(19) United States
(12) Patent Application Publication
(10) Pub. No.: US 2026/0129462 A1
(43) Pub. Date: May 7, 2026

(54) SYSTEMS AND METHODS FOR IDENTIFYING A MISSING ANCHOR BETWEEN A FIFTH-GENERATION BASE STATION AND A FOURTH-GENERATION BASE STATION

(71) Applicant: Verizon Patent and Licensing Inc., Basking Ridge, NJ (US)

(72) Inventors: Manojkumar SEKAR, Chennai (IN); Vamshi Mohan DEVANAPALLI RAMAYA, Hyderabad (IN); Arun CHERLA, Basking Ridge, NJ (US); Abhitabh KUSHWAHA, Tampa, FL (US)

(73) Assignee: Verizon Patent and Licensing Inc., Basking Ridge, NJ (US)

(21) Appl. No.: 18/936,169

(22) Filed: Nov. 4, 2024

(51) Int. Cl. H04W 16/14

(52) U.S. Cl. CPC H04W 16/14

(57) ABSTRACT

A device may receive, from a first fifth-generation (5G) base station, first data identifying first customers missing an anchor to a fourth-generation (4G) base station and first customers in a first coverage overlap area, and may receive, from a second 5G base station, second data identifying second customers missing an anchor to the 4G base station and second customers in a second coverage overlap area. The device may select one of the first 5G base station or the second 5G base station for an anchor with the 4G base station based on the first data and the second data, and may cause the 4G base station to establish an anchor with the one of the first 5G base station or the second 5G base station.

### BACKGROUND

A customer (e.g., with a fixed wireless access (FWA) device, a user equipment (UE), and/or the like) may connect with a fifth-generation (5G) base station (e.g., a gNodeB or gNB) in a 5G non-stand-alone (NSA) approach by establishing an anchor between the 5G base station and a fourth-generation (4G) base station (e.g., an eNodeB or eNB).

### BRIEF DESCRIPTION OF THE DRAWINGS

FIGS. 1A-1G are diagrams of an example associated with identifying a missing anchor between a 5G base station and a 4G base station.

FIG. 2 is a diagram of an example environment in which systems and/or methods described herein may be implemented.

FIG. 3 is a diagram of example components of one or more devices of FIG. 2.

FIG. 4 is a flowchart of an example process for identifying a missing anchor between a 5G base station and a 4G base station.

### DETAILED DESCRIPTION OF EXAMPLE EMBODIMENTS

The following detailed description of example implementations refers to the accompanying drawings. The same reference numbers in different drawings may identify the same or similar elements.

Operators utilize anchors between 4G base stations and 5G base stations to ensure connectivity and service in 5G non-stand-alone (NSA) approaches. However, the dynamic nature of network usage and the geographic distribution of customers can lead to situations where anchors are missing or not optimally placed. Network performance must be constantly monitored to identify and add these missing anchors, a process that requires significant effort and can still fail to adequately address customer impact. Current techniques for adding missing anchors rely on network coverage overlap and geographical distances between 4G base stations and 5G base stations. These techniques fail to consider customer experience, priorities of services, usage patterns, and/or the like when adding missing anchors. For example, a coverage-based approach for anchor addition may lead to suboptimal customer experiences if areas with higher overlap fail to coincide with areas where customers are most impacted by service issues. Thus, current techniques for determining 4G base stations as anchors for 5G base stations consume computing resources (e.g., processing resources, memory resources, communication resources, and/or the like), networking resources, and/or other resources associated with failing to adapt quickly to fluctuating network demands, incorrectly identifying anchors, causing network inefficiencies and connectivity issues due to incorrectly identifying anchors, causing a poor customer experience for a customer of a fixed wireless access (FWA) device due to incorrectly identifying anchors, and/or the like.

Some implementations described herein provide a self-organizing network (SON) system that identifies a missing anchor between a 5G base station and a 4G base station. For example, the SON system may receive, from a first 5G base station, first data identifying first customers missing an anchor to a 4G base station and first customers in a first coverage overlap area, and may receive, from a second 5G base station, second data identifying second customers missing an anchor to the 4G base station and second customers in a second coverage overlap area. The SON system may select one of the first 5G base station or the second 5G base station for an anchor with the 4G base station based on the first data and the second data, and may cause the 4G base station to establish an anchor with the one of the first 5G base station or the second 5G base station.

In this way, the SON system identifies a missing anchor between a 5G base station and a 4G base station. For example, the SON system may dynamically identify which connections would benefit from a new or adjusted anchor based on real-time data, and may prioritize anchor placement based on metrics, such as network throughput and resource allocation, rather than solely on geographic coverage overlap. The SON system may also reduce a need for intervention by network engineers, and may increase operational efficiency of a network. By prioritizing anchor connections based on actual network performance metrics and service requirements, the SON system may provide targeted improvements to optimize network capacity and handling of high-priority traffic, such as traffic associated with FWA devices. Thus, the SON system may conserve computing resources, networking resources, and/or other resources that would have otherwise been consumed by failing to adapt quickly to fluctuating network demands, incorrectly identifying anchors, causing network inefficiencies and connectivity issues due to incorrectly identifying anchors, causing a poor customer experience for a customer of an FWA device due to incorrectly identifying anchors, and/or the like.

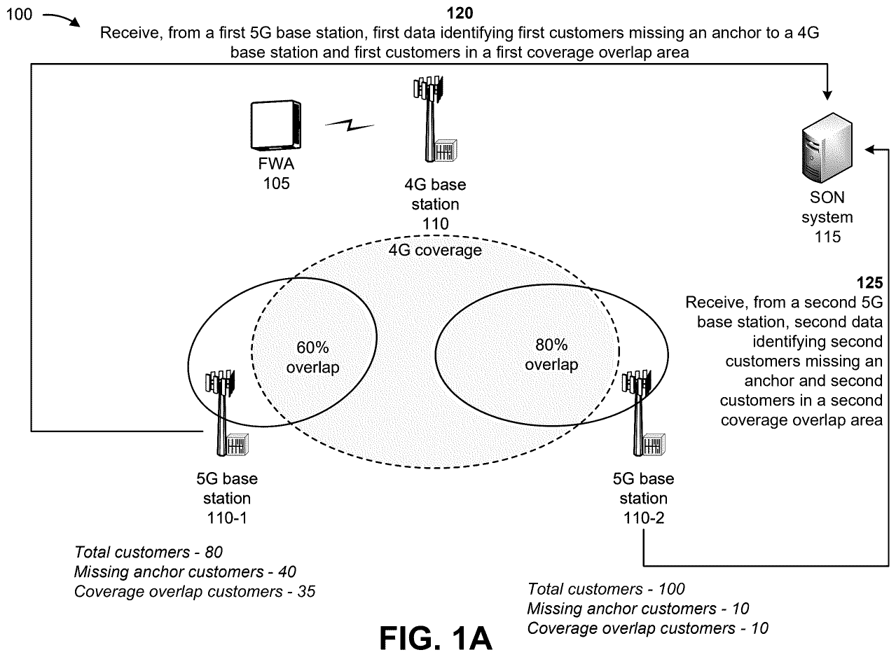

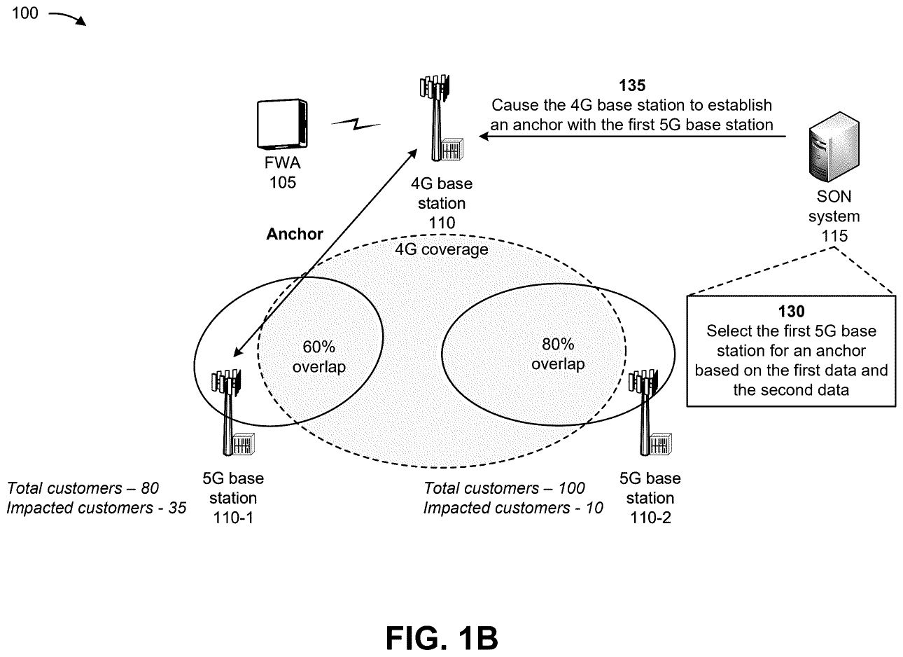

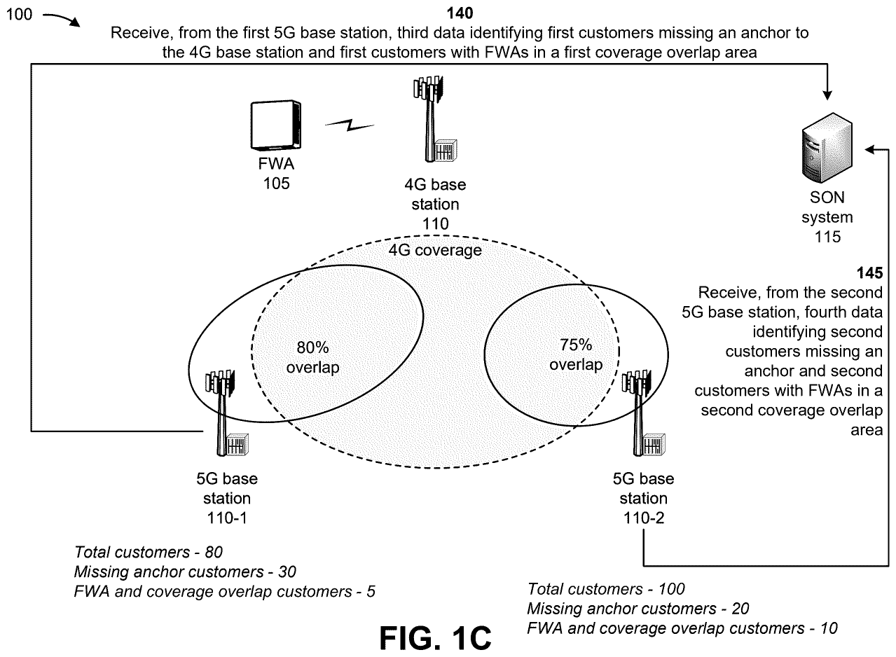

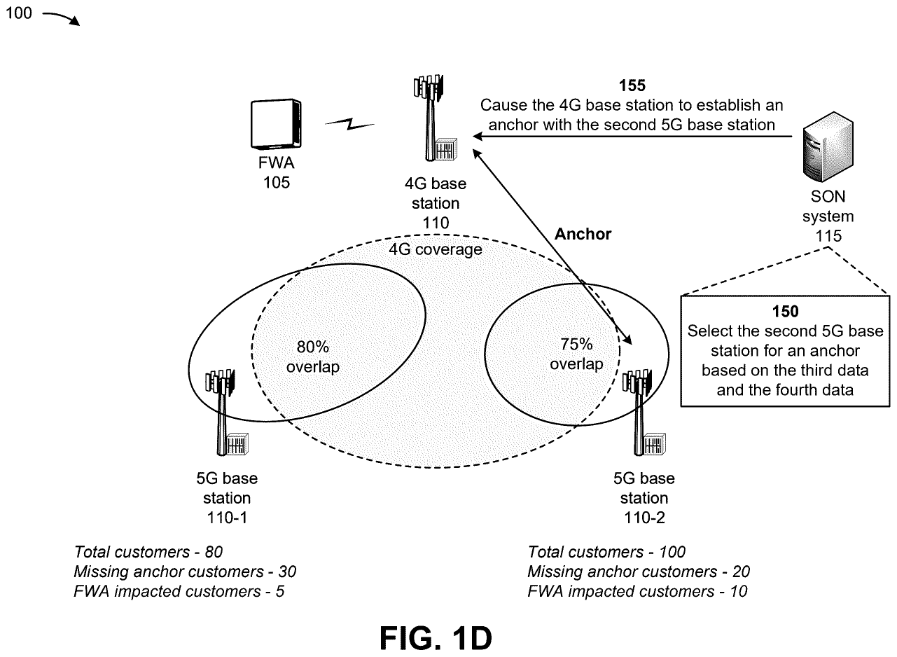

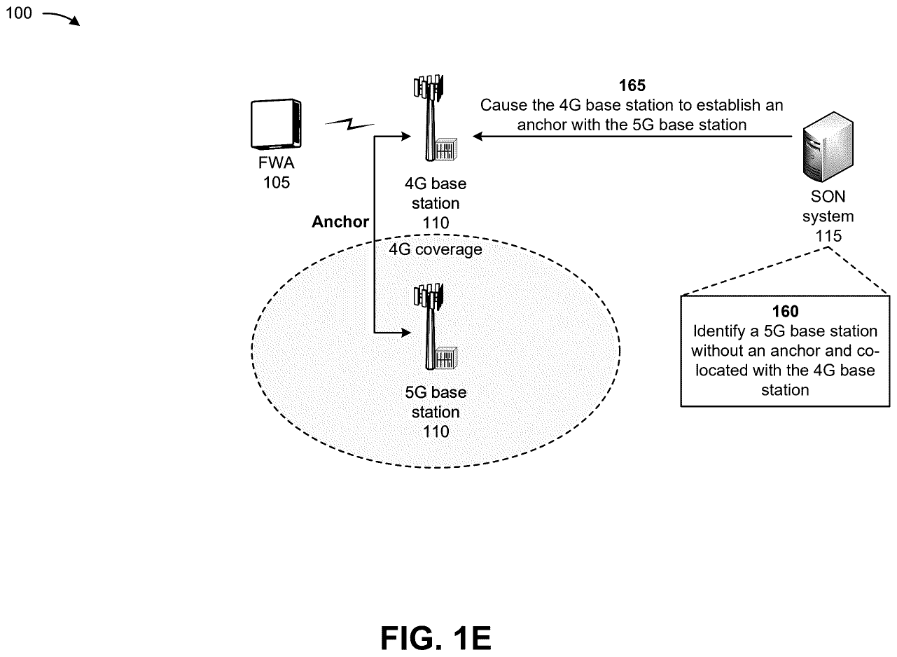

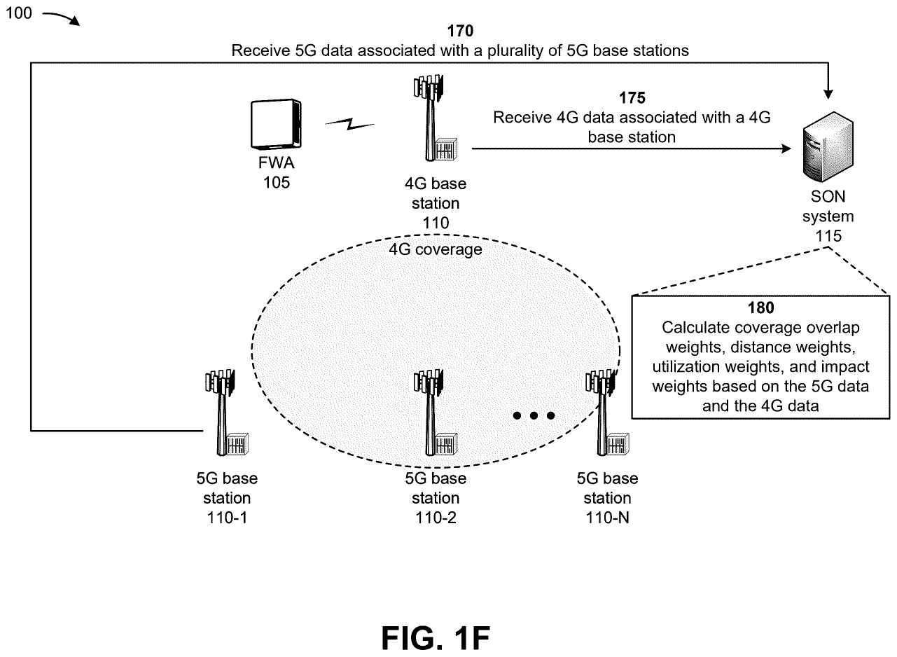

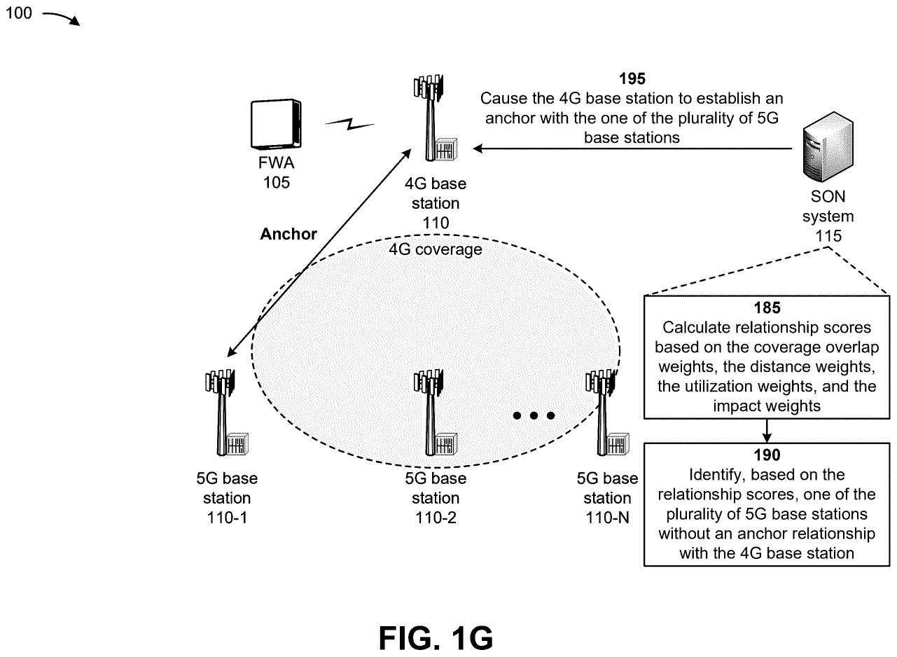

FIGS. 1A-1G are diagrams of an example 100 associated with identifying a missing anchor between a 5G base station and a 4G base station. As shown in FIGS. 1A-1G, the example 100 includes an FWA device 105 associated with 5G base stations 110 (e.g., a first 5G base station 110-1 and a second 5G base station 110-2), a 4G base station 110, and a SON system 115. Further details of the FWA device 105, the 4G base station 110, the 5G base stations 110, and the SON system 115 are provided elsewhere herein. Although implementations are described herein in connection with the FWA device 105, the implementations may be utilized with devices other than the FWA device 105, such as a mobile hotspot device, customer premises equipment (CPE), a wireless access point (WAP), a wireless router, a modem, a set-top box (STB), a base transceiver station (BTS), a repeater device, a small cell (e.g., a femtocell, a picocell, and microcell), a telecommunication gateway, and/or the like.

As shown in FIGS. 1A and 1B, the 4G base station 110 may provide a 4G coverage area that overlaps (e.g., a 60% first coverage area overlap) with a 5G coverage area provided by the first 5G base station 110-1. The 4G coverage area may overlap (e.g., an 80% second coverage area overlap) with a 5G coverage area provide by the second 5G base station 110-2. The 4G base station 110 may include one sector carrier where one anchor relation can be established with one of the 5G base stations 110. The first 5G base station 110-1 may include one sector carrier with forty (40) customers impacted by a missing anchor and thirty-five (35) customers in the first coverage overlap area. The second 5G base station 110-2 may include one sector carrier with ten (10) customers impacted by a missing anchor and ten (10) customers in the second coverage overlap area.

As further shown in FIG. 1A, and by reference number 120, the SON system 115 may receive, from the first 5G base station 110-1, first data identifying first customers missing an anchor to the 4G base station 110 and first customers in the first coverage overlap area. For example, the SON system 115 may continuously receive the first data from the first 5G base station 110-1, may periodically receive the first data from the first 5G base station 110-1, may receive the first data from the first 5G base station 110-1 based on requesting the first data, and/or the like. The first data may include information about first customers lacking an anchor to the 4G base station 110 and first customers located within the first coverage overlap area with the 4G base station 110. The first data may provide insight into customers who may benefit from more stable connections.

Additionally, or alternatively, the SON system 115 may receive, from the first 5G base station 110-1, performance metrics identifying customers that would experience service improvements with optimized anchor relationships with the 4G base station 110. For example, the performance metrics may include data identifying connection attempts and signal strength. Additionally, or alternatively, the SON system 115 may receive comprehensive data identifying a service footprint of the first 5G base station 110-1 and customer density maps in the first coverage overlap area, and may determine the first customers without an anchor link to the 4G base station 110 and the first customers in the first coverage overlap area based on the comprehensive data.

As further shown in FIG. 1A, and by reference number 125, the SON system 115 may receive, from the second 5G base station 110-2, second data identifying second customers missing an anchor and second customers in the second coverage overlap area. For example, the SON system 115 may continuously receive the second data from the second 5G base station 110-2, may periodically receive the second data from the second 5G base station 110-2, may receive the second data from the second 5G base station 110-2 based on requesting the second data, and/or the like. The second data may include information about second customers lacking an anchor to the 4G base station 110 and second customers located within the second coverage overlap area with the 4G base station 110. The second data may provide insight into customers who may benefit from more stable connections.

Additionally, or alternatively, the SON system 115 may receive, from the second 5G base station 110-2, performance metrics identifying customers that would experience service improvements with optimized anchor relationships with the 4G base station 110. For example, the performance metrics may include data identifying connection attempts and signal strength. Additionally, or alternatively, the SON system 115 may receive comprehensive data identifying a service footprint of the second 5G base station 110-2 and customer density maps in the second coverage overlap area, and may determine the second customers without an anchor link to the 4G base station 110 and the second customers in the second coverage overlap area based on the comprehensive data.

As shown in FIG. 1B, and by reference number 130, the SON system 115 may select the first 5G base station 110-1 for an anchor based on the first data and the second data. For example, when selecting the first 5G base station 110-1 for the anchor with the 4G base station 110, the SON system 115 may prioritize the first 5G base station 110-1 for the anchor due to higher network utilization rates of the first 5G base station 110-1. The higher utilization rates may indicate that the first 5G base station 110-1 is better equipped to handle increased traffic over the second 5G base station 110-2, thus ensuring efficient network performance. Additionally, or alternatively, the SON system 115 may utilize machine learning models to predict a best 5G base station 110 for establishing an anchor. The machine learning models may analyze historical data and predict future network performance, allowing for a more accurate selection process. Additionally, or alternatively, the SON system 115 may consider both real-time and historical data when selecting the first 5G base station 110-1 for an anchor with the 4G base station 110. Real-time data may ensure that current network conditions are considered, while historical data provides context on past performance patterns.

Additionally, or alternatively, the SON system 115 may use the first data and the second data to calculate weights for coverage overlap, distance to the 4G base station 110, and network load before selecting the first 5G base station 110-1 or the second 5G base station 110-2 for the anchor. These weighted factors may contribute to a more balanced and comprehensive decision-making process. Additionally, or alternatively, besides customer impact, the SON system 115 may include additional criteria, such as device types or service plans, when selecting a suitable 5G base station 110 for anchoring. Different devices and service plans may have varying requirements, thus influencing the selection process. Additionally, or alternatively, the SON system 115 may select the first 5G base station 110-1 based on a better balance of coverage area and a quantity of customers affected compared to the second 5G base station 110-2. This approach may ensure that the selected 5G base station 110 optimally serves the maximum quantity of customers with minimal coverage gaps.

Additionally, or alternatively, the SON system 115 may utilize data about specific applications heavily used by customers when selecting a 5G base station 110 for an anchor. For example, if customers frequently use high-bandwidth applications, the selected 5G base station 110 should be capable of supporting these applications efficiently. Additionally, or alternatively, the SON system 115 may dynamically adjust selection criteria to prioritize 5G base stations 110 with more stable connections as potential anchors with the 4G base station 110. Stability metrics may include factors, such as fewer dropped connections or higher signal quality over time. Additionally, or alternatively, the SON system 115 may utilize a projected future load when selecting the first 5G base station 110-1 for an anchor with the 4G base station 110. A projected load analysis may aid in anticipating future network demands and preparing accordingly. Additionally, or alternatively, the SON system 115 may utilize customer behavior analytics in the selection process to ensure a more customer-centric approach for anchoring decisions. Customer behavior may include patterns of mobility, typical application usage, and peak activity times.

Current techniques may select the second base station 110-2 for the anchor based on the second 5G base station 110-2 having a better coverage overlap (e.g., 80% overlap) with the 4G base station 110 than the first 5G base station 110-1 (e.g., 60% overlap). However, such a selection may result in an improvement for only ten (10) customers. In implementations described herein, the SON system 115 may balance coverage overlap and customer impact when selecting a 5G base station 110 for the anchor. For example, the SON system 115 may determine that if the first 5G base station 110-1 is selected, thirty-five (35) customers will experience an improvement, and that if the second base station 110-2 is selected, ten (10) customers will experience an improvement. Based on this determination, the SON system 115 may select the first 5G base station 110-1 for the anchor since the quantity of customers (e.g., 35) experiencing an improvement is greater that quantity of customers (e.g., 10) experiencing an improvement if the second 5G base station 110-2 is selected.

As further shown in FIG. 1B, and by reference number 135, the SON system 115 may cause the 4G base station 110 to establish an anchor with the first 5G base station 110-1. For example, the SON system 115 may configure parameters and protocols on the 4G base station 110 and the first 5G base station 110-1 to enable seamless communication and improved network performance for impacted customers. The anchoring process may involve multiple steps, such as initializing handshakes between base stations 110, synchronizing operational parameters, and confirming stable connectivity. Additionally, or alternatively, the SON system 115 might not only establish the anchor but also may periodically review and optimize the anchor based on ongoing network performance metrics and customer feedback. This ongoing review may ensure that the established anchor continues to provide the best possible service. Additionally, or alternatively, to enhance network efficiency, the SON system 115 may establish a temporary anchor with the first 5G base station 110-1 during peak hours and may remove the anchor during off-peak times based on load balancing requirements. Time-based anchoring may aid in managing network load effectively during varying demand periods.

As shown in FIGS. 1C and 1D, the 4G base station 110 may provide a 4G coverage area that overlaps (e.g., an 80% first coverage overlap area) with a 5G coverage area provided by the first 5G base station 110-1. The 4G coverage area may overlap (e.g., a 75% second coverage overlap area) with a 5G coverage area provide by the second 5G base station 110-2. The 4G base station 110 may include one sector carrier where one anchor relation can be established with one of the 5G base stations 110. The first 5G base station 110-1 may include one sector carrier with thirty (30) customers impacted by a missing anchor and five (5) customers with FWA devices 105 in the first coverage overlap area. The second 5G base station 110-2 may include one sector carrier with twenty (20) customers impacted by a missing anchor and ten (10) customers with FWA devices 105 in the second coverage overlap area.

As further shown in FIG. 1C, and by reference number 140, the SON system 115 may receive, from the first 5G base station 110-1, third data identifying first customers missing an anchor to the 4G base station 110 and first customers with FWA devices 105 in a first coverage overlap area. For example, the SON system 115 may continuously receive the third data from the first 5G base station 110-1, may periodically receive the third data from the first 5G base station 110-1, may receive the third data from the first 5G base station 110-1 based on requesting the third data, and/or the like. The third data may include information about first customers lacking an anchor to the 4G base station 110 and first customers with FWA devices 105 located within the first coverage overlap area with the 4G base station 110. The third data may provide insight into customers with FWA devices 105 who may benefit from more stable connections.

Additionally, or alternatively, the SON system 115 may receive, from the first 5G base station 110-1, performance metrics identifying customers that would experience service improvements with optimized anchor relationships with the 4G base station 110. For example, the performance metrics may include data identifying connection attempts and signal strength. Additionally, or alternatively, the SON system 115 may receive comprehensive data identifying a service footprint of the first 5G base station 110-1 and customer density maps in the first coverage overlap area, and may determine the first customers without an anchor link to the 4G base station 110 and the first customers with the FWA devices 105 in the first overlapping coverage territory based on the comprehensive data.

As further shown in FIG. 1C, and by reference number 145, the SON system 115 may receive, from the second 5G base station 110-2, fourth data identifying second customers missing an anchor and second customers with FWA devices 105 in a second coverage overlap area. For example, the SON system 115 may continuously receive the fourth data from the second 5G base station 110-2, may periodically receive the fourth data from the second 5G base station 110-2, may receive the fourth data from the second 5G base station 110-2 based on requesting the fourth data, and/or the like. The fourth data may include information about second customers lacking an anchor to the 4G base station 110 and second customers with FWA devices 105 located within the second coverage overlap area with the 4G base station 110. The fourth data may provide insight into customers who may benefit from more stable connections.

Additionally, or alternatively, the SON system 115 may receive, from the second 5G base station 110-2, performance metrics identifying customers that would experience service improvements with optimized anchor relationships with the 4G base station 110. For example, the performance metrics may include data identifying connection attempts and signal strength. Additionally, or alternatively, the SON system 115 may receive comprehensive data identifying a service footprint of the second 5G base station 110-2 and customer density maps in the second coverage overlap area, and may determine the second customers without an anchor link to the 4G base station 110 and the second customers in the first overlapping coverage territory based on the comprehensive data.

As shown in FIG. 1D, and by reference number 150, the SON system 115 may select the second 5G base station 110-2 for an anchor based on the third data and the fourth data. For example, when selecting the second 5G base station 110-2 for the anchor with the 4G base station 110, the SON system 115 may prioritize the second 5G base station 110-2 for the anchor due to higher network utilization rates of the second 5G base station 110-2. The higher utilization rates may indicate that the second 5G base station 110-2 is better equipped to handle increased traffic over the first 5G base station 110-1, thus ensuring efficient network performance. Additionally, or alternatively, the SON system 115 may utilize machine learning models to predict a best 5G base station 110 for establishing an anchor. The machine learning models may analyze historical data and predict future network performance, allowing for a more accurate selection process. Additionally, or alternatively, the SON system 115 may consider both real-time and historical data when selecting the second 5G base station 110-2 for an anchor with the 4G base station 110. Real-time data may ensure that current network conditions are considered, while historical data provides context on past performance patterns.

Additionally, or alternatively, the SON system 115 may use the first data and the second data to calculate weights for coverage overlap, distance to the 4G base station 110, and network load before selecting the first 5G base station 110-1 or the second 5G base station 110-2 for the anchor. These weighted factors may contribute to a more balanced and comprehensive decision-making process. Additionally, or alternatively, besides customer impact, the SON system 115 may include additional criteria, such as device types or service plans, when selecting a suitable 5G base station 110 for anchoring. Different devices and service plans may have varying requirements, thus influencing the selection process. Additionally, or alternatively, the SON system 115 may select the second 5G base station 110-2 based on a better balance of coverage area and a quantity of customers affected compared to the first 5G base station 110-1. This approach may ensure that the selected 5G base station 110 optimally serves the maximum quantity of customers with minimal coverage gaps.

Additionally, or alternatively, the SON system 115 may utilize data about specific applications heavily used by customers when selecting a 5G base station 110 for an anchor. For example, if customers frequently use high-bandwidth applications, the selected 5G base station 110 should be capable of supporting these applications efficiently. Additionally, or alternatively, the SON system 115 may dynamically adjust selection criteria to prioritize 5G base stations 110 with more stable connections as potential anchors with the 4G base station 110. Stability metrics may include factors, such as fewer dropped connections or higher signal quality over time. Additionally, or alternatively, the SON system 115 may utilize a projected future load when selecting the second 5G base station 110-2 for an anchor with the 4G base station 110. A projected load analysis may aid in anticipating future network demands and preparing accordingly. Additionally, or alternatively, the SON system 115 may utilize customer behavior analytics in the selection process to ensure a more customer-centric approach for anchoring decisions. Customer behavior may include patterns of mobility, typical application usage, and peak activity times.

Current techniques may select the first base station 110-1 for the anchor based on the first 5G base station 110-1 having a better coverage overlap (e.g., 80% overlap) with the 4G base station 110 than the second 5G base station 110-2 (e.g., 75% overlap). However, such a selection may result in an improvement for only five (5) customers with FWA devices 105. In implementations described herein, the SON system 115 may balance coverage overlap, customer impact, a device prioritization when selecting a 5G base station 110 for the anchor. For example, the SON system 115 may determine that if the first 5G base station 110-1 is selected, five (5) customers with FWA devices 105 will experience an improvement, and that if the second base station 110-2 is selected, ten (10) customers with FWA devices 105 will experience an improvement. Based on this determination, the SON system 115 may select the second 5G base station 110-2 for the anchor since the quantity of customers (e.g., 10) with FWA devices 105 experiencing an improvement is greater that quantity of customers (e.g., 5) with FWA devices 105 experiencing an improvement if the first 5G base station 110-1 is selected.

As further shown in FIG. 1D, and by reference number 155, the SON system 115 may cause the 4G base station 110 to establish an anchor with the second 5G base station 110-2. For example, the SON system 115 may configure parameters and protocols on the 4G base station 110 and the second 5G base station 110-2 to enable seamless communication and improved network performance for impacted customers. The anchoring process may involve multiple steps, such as initializing handshakes between base stations 110, synchronizing operational parameters, and confirming stable connectivity. Additionally, or alternatively, the SON system 115 might not only establish the anchor but also may periodically review and optimize the anchor based on ongoing network performance metrics and customer feedback. This ongoing review may ensure that the established anchor continues to provide the best possible service.

Additionally, or alternatively, to enhance network efficiency, the SON system 115 may establish a temporary anchor with the second 5G base station 110-2 during peak hours and may remove the anchor during off-peak times based on load balancing requirements. Time-based anchoring may aid in managing network load effectively during varying demand periods.

As shown in FIG. 1E, the 4G base station 110 and the 5G base station 110 may be available at a same site, and the 5G base station 110 may include a sector carrier with anchors established with other 4G base stations 110 but not with the 4G base station 110 available at the same site. Stationary devices, such as FWA devices 105, may not be moved. Thus, providing at least one anchor relation between the 5G base station 110 and the 4G base station 110 within the same site may prevent impacting customers with FWA devices 105 at the same site.

As further shown in FIG. 1E, and by reference number 160, the SON system 115 may identify a 5G base station 110 without an anchor and co-located with the 4G base station 110. For example, the SON system 115 may analyze a deployment of the 5G base station 110 to determine whether the 5G base station 110 is situated at a same site as the 4G base station 110 but lacks an established anchor. This identification may be based on geographic data indicating precise locations of the 5G base station 110 and the 4G base station and operational data specifying existing anchor relations. In some implementations, identifying a 5G base station 110 without an anchor may include the SON system 115 querying a database of current network configurations to verify presence of unanchored base stations 110. Additionally, or alternatively, identifying a 5G base station 110 without an anchor may include the SON system 115 utilizing geographic information system (GIS) data to identify 5G base station 110 locations that have no established anchor with nearby 4G base stations 110. GIS data may provide precise spatial analysis to pinpoint areas that require anchor establishment based on physical proximity and coverage overlaps.

Additionally, or alternatively, identifying a 5G base station 110 without an anchor may include the SON system 115 analyzing network logs to identify instances where the 5G base station 110 is frequently failing to connect to the 4G base station 110, which may be indicative of a missing anchor. Network logs may provide historical and real-time insights into connectivity issues, thereby highlighting potential gaps in the anchor relationships. Additionally, or alternatively, identifying a 5G base station 110 without an anchor may include the SON system 115 performing real-time scanning to identify 5G base stations 110 without active anchor relationships with 4G base stations 110 based on detection of device handover failures. Additionally, or alternatively, identifying a 5G base station 110 without an anchor may include the SON system 115 mining historical customer device connection data to identify co-located but unanchored 4G and 5G base stations 110. Analyzing customer connection histories may enable the SON system 115 to make data-driven decisions on necessary anchor establishments based on observed customer patterns.

As further shown in FIG. 1E, and by reference number 165, the SON system 115 may cause the 4G base station 110 to establish an anchor with the 5G base station 110. For example, based on the identification of the missing anchor, the SON system 115 may configure the necessary parameters and initiate protocols on both the 4G base station 110 and the 5G base station 110 to form a stable anchor link. The anchor establishment process may include steps such as synchronization of operational parameters and confirmation of connectivity to ensure seamless communication and improved network performance for customers, particularly customers with FWA devices 105 located in the same site. In some implementations, establishing the anchor may include initiating software updates and configuration changes to the 4G base station 110 and the 5G base station 110. Additionally, or alternatively, establishing the anchor may include instructing the 4G base station 110 to broadcast synchronization signals to the 5G base station 110. This may ensure that the 4G base station 110 and the 5G base station 110 operate in concert, reducing latency and enhancing throughput for connected devices.

Additionally, or alternatively, establishing the anchor may include commanding the 4G base station 110 to allocate specific resources and channels for exclusive communication with the 5G base station 110. Resource allocation may ensure dedicated pathways for inter-base-station communication, minimizing contention and maximizing performance. Additionally, or alternatively, establishing the anchor may include executing a multi-step protocol handshake between the 4G base station 110 and the 5G base station 110 to verify signal compatibility and readiness before finalizing the anchor establishment. The handshake sequence may ensure that all technical prerequisites are satisfied, thereby preventing potential operational issues. Additionally, or alternatively, establishing the anchor may include triggering an automatic anchor setup between the 4G base station 110 and the 5G base station 110 based on anomalies in customer data rates monitored by the SON system 115. Monitoring customer data rates helps in dynamically adjusting the network architecture to maintain consistent service quality.

As shown in FIGS. 1F and 1G, the 4G base station 110 may be associated with a plurality of 5G base stations 110 that may be missing anchor relationships with the 4G base station 110. As further shown in FIG. 1F, and by reference number 170, the SON system 115 may receive 5G data associated with the plurality of 5G base stations 110. For example, the SON system 115 may continuously receive the 5G data from the plurality of 5G base stations 110, may periodically receive the 5G data from the plurality of 5G base stations 110, may receive the 5G data from the plurality of 5G base stations 110 based on requesting the 5G data, and/or the like. The 5G data may include information identifying network parameters, such as signal strength, connection quality, customer density, and usage patterns. The 5G data may enable the SON system 115 to determine a traffic load and a performance of each 5G base station 110. In some implementations, the 5G data may include real-time performance metrics associated with the plurality of 5G base stations 110, such as signal interference levels, handover success rates, and customer service quality indices.

Additionally, or alternatively, the SON system 115 may receive historical data trends from the plurality of 5G base stations 110 for analyzing longer-term performance patterns and predict future system requirements. Additionally, or alternatively, the SON system 115 may periodically query the plurality of 5G base stations 110 for updated configuration and status reports to ensure that the plurality of 5G base stations are optimized for varying operational conditions. Additionally, or alternatively, the SON system 115 may aggregate the 5G data from multiple sources, including external systems like customer service databases or network monitoring tools.

As further shown FIG. 1F, and by reference number 175, the SON system 115 may receive 4G data associated with a 4G base station 110. For example, the SON system 115 may continuously receive the 4G data from the 4G base station 110, may periodically receive the 4G data from the 4G base station 110, may receive the 4G data from the 4G base station 110 based on requesting the 4G data, and/or the like. The 4G data may include information about the operational status, customer connectivity details, signal quality and coverage areas, traffic loads, and anchor status of the 4G base station 110. In some implementations, the SON system 115 may receive outage reports and performance degradation alerts from the 4G base station 110, enabling rapid response to network issues. Outage reports and degradation alerts may enable the SON system 115 to quickly identify and resolve connectivity problems. Additionally, or alternatively, the SON system 115 may receive detailed customer activity logs from the 4G base station 110 and may analyze specific user behavior and connectivity patterns based on the customer activity logs.

As further shown FIG. 1F, and by reference number 180, the SON system 115 may calculate coverage overlap weights, distance weights, utilization weights, and impact weights based on the 5G data and the 4G data. For example, the SON system 115 may utilize parameters when calculating the coverage overlap weights, the distance weights, the utilization weights, and the impact weights based on the 5G data and the 4G data. The parameters may include a quantity (x) of failed/poor 5G connection attempts from devices to the plurality of 5G base stations 110 (e.g., that trigger a search for a missing relationship); a distance threshold (Dt) that indicates a maximum distance allowed between the 4G base station 110 and a 5G base station 110 for a relationship to exist; a utilization threshold (Ut) that indicates a minimum acceptable utilization percentage for the 4G base station 110; a product weight (Pw) that indicates a weight assigned to each product and plan type (e.g., a home FWA device 105 plan, a 5G mobility plan, and/or the like); and a relationship score threshold (Rt) that indicates a minimum relationship score for considering a pair of the 4G base station 110 and one of the plurality of 5G base stations 110 as a potential anchor relationship.

A coverage overlap weight (Cw) may provide an indication of an effectiveness of coverage redundancy. The SON system 115 may calculate coverage overlap weights based on areas where coverage provided by the 4G base station 110 and the plurality of 5G base stations 110 intersect. For example, the SON system 115 may calculate a coverage overlap weight (Cw) for the 4G base station 110 sector (E) and a 5G base station 110 sector (G) as follows:

Cw(G, E)=Area(G∩E)/Area(G∪E),

which is a ratio of an intersection area to a union area of the 4G base station 110 and the 5G base station 110 coverage areas.

A distance weight (Dw) may assess a proximity of the 4G base station 110 and the 5G base station 110 to ensure minimal latency and optimal communication quality. The SON system 115 may calculate distance weights based on a calculated geographical distance between the 4G base station 110 and the plurality of 5G base stations 110. For example, the SON system 115 may calculate a distance weight (Dw) for the 4G base station 110 sector (E) and a 5G base station 110 sector (G) as follows:

Dw(G, E)=1/(1+(Distance(G, E)/Dt)2).

This function may assign a higher weight to closer base stations 110 and may decrease the weight as the distance increases, becoming negligible beyond the distance threshold (Dt).

A utilization weight (Uw) may assess an existing load to avoid overloading a particular base station 110. The SON system 115 may calculate utilization weights based on the traffic loads and network usage of the 4G base station 110 and the plurality of 5G base stations 110. For example, the SON system 115 may calculate a utilization weight (Uw) for the 4G base station 110 sector (E) and a 5G base station 110 sector (G) as follows:

Uw(E)=Utilization(E)/Ut, if Utilization(E)<Ut, and

Uw(E)=1, if Utilization(E)≥Ut.

This function may assign a weight of one to 5G base stations 110 that satisfy the utilization threshold (Ut) and a lower weight to 5G base stations 110 that fail to satisfy the utilization threshold (e.g., which may indicate availability).

An impact weight (Iw) may assess customer satisfaction and prioritization of areas needing improvement. The SON system 115 may calculate impact weights based on a quantity of customers impacted by coverage overlap and traffic handling capacity of the base stations 110. For example, the SON system 115 may calculate an impact weight (Iw) for the 4G base station 110 sector (E) and a 5G base station 110 sector (G) as follows:

Iw(G, E)=Σ(Np(G)*Pw(p)),

where Np(G) corresponds to a quantity of devices with a product/plan type (p) that attempted connection to the 4G base station 110 and failed or experienced poor 5G connectivity, and Pw(p) corresponds to a pre-defined weight for the product/plan type (p).

These calculated weights may enable the SON system 115 to make accurate and efficient determinations regarding anchor establishments. In some implementations, the SON system 115 may calculate interference weights based on the presence of overlapping frequency usage between the 4G base station 110 and the plurality of 5G base stations 110, which could affect signal quality. Additionally, or alternatively, the SON system 115 may factor in temporal utilization weights, accounting for peak hours usage to optimize anchor assignments during high traffic periods. Temporal utilization weights may ensure that resources are allocated efficiently during varying traffic loads. Additionally, or alternatively, the SON system 115 may dynamically assign one or more of the weights based on real-time changes in network conditions, such as sudden spikes in usage or environmental factors affecting signal propagation. Dynamic adjustment of weights may enable the network to adapt responsively to sudden shifts in conditions. Additionally, or alternatively, the SON system 115 may incorporate customer experience feedback into the impact weights, allowing customer satisfaction metrics to directly influence network optimization decisions.

As shown in FIG. 1G, and by reference number 185, the SON system 115 may calculate relationship scores based on the coverage overlap weights, the distance weights, the utilization weights, and the impact weights. For example, the SON system 115 may determine anchor necessities for the plurality of 5G base stations 110 by calculating relationship scores using the coverage overlap weights, the distance weights, the utilization weights, and the impact weights calculated for the plurality of 5G base stations 110. In some implementations, the SON system 115 may calculate a relationship score (Rs) for the 4G base station 110 and one of the plurality of 5G base stations 110 by multiplying the calculated weights as follows:

Rs(G, E)=Cw(G, E)*Dw(G, E)*Uw(E)*Iw(G, E).

The relationship scores may aid in determining the criticality and prioritization of the plurality of 5G base stations 110 requiring an anchor to 4G base station 110. Additionally, or alternatively, the SON system 115 may identify the most effective 5G base stations 110 for anchoring based on the relationships scores. Additionally, or alternatively, when calculating the relationship scores, the SON system 115 may incorporate metrics, such as overlap between coverage areas, geographical distance, existing traffic loads, and customer impact, to evaluate network redundancy and stability. This multifaceted analysis may ensure that network performance is optimized and potential load imbalances are mitigated.

As further shown in FIG. 1G, and by reference number 190, the SON system 115 may identify, based on the relationship scores, one of the plurality of 5G base stations 110 without an anchor relationship with the 4G base station 110. For example, the SON system 115 may compare the calculated relationship scores with the relationship score threshold (Rt) to determine whether the plurality of 5G base stations 110 include an anchor relationship with the 4G base station 110. In some implementations, when a relationship score is greater than or equal to the relationship score threshold, the SON system 115 may determine that the corresponding 5G base station requires an anchor relationship with the 4G base station 110 (e.g., if one is not already established). Alternatively, when a relationship score is less than the relationship score threshold, the SON system 115 may determine that the corresponding 5G base station cannot establish an anchor relationship with the 4G base station 110. In some implementations, the SON system 115 may identify which of the plurality of 5G base stations 110 lack an anchor to the 4G base station 110 based on the calculated relationship scores. This may enable the SON system 115 to address unoptimized base stations 110 and enhance their connectivity. Additionally, or alternatively, the SON system 115 may utilize the relationship scores to identify unanchored 5G base stations 110 that could benefit from an anchor relationship with 4G base station 110.

As further shown in FIG. 1G, and by reference number 195, the SON system 115 may cause the 4G base station 110 to establish an anchor with the one of the plurality of 5G base stations 110. For example, the SON system 115 may configure the 4G base station 110 to establish an anchor with the one of the plurality of 5G base stations 110. The anchor establishment process may include steps such as synchronization of operational parameters and confirmation of connectivity to ensure seamless communication and improved network performance for customers. In some implementations, establishing the anchor may include initiating software updates and configuration changes to the 4G base station 110 and the one of the plurality of 5G base stations 110. Additionally, or alternatively, establishing the anchor may include instructing the 4G base station 110 to broadcast synchronization signals to the one of the plurality of 5G base stations 110. This may ensure that the 4G base station 110 and the one of the plurality of 5G base stations 110 operate in concert, reducing latency and enhancing throughput for connected devices.

Additionally, or alternatively, establishing the anchor may include commanding the 4G base station 110 to allocate specific resources and channels for exclusive communication with the one of the plurality of 5G base stations 110. Resource allocation may ensure dedicated pathways for inter-base-station communication, minimizing contention and maximizing performance. Additionally, or alternatively, establishing the anchor may include executing a multi-step protocol handshake between the 4G base station 110 and the one of the plurality of 5G base stations 110 to verify signal compatibility and readiness before finalizing the anchor establishment. The handshake sequence may ensure that all technical prerequisites are satisfied, thereby preventing potential operational issues. Additionally, or alternatively, establishing the anchor may include triggering an automatic anchor setup between the 4G base station 110 and the one of the plurality of 5G base stations 110 based on anomalies in customer data rates monitored by the SON system 115. Monitoring customer data rates helps in dynamically adjusting the network architecture to maintain consistent service quality.

In this way, the SON system 115 identifies a missing anchor between a 5G base station 110 and a 4G base station 110. For example, the SON system 115 may dynamically identify which connections would benefit from a new or adjusted anchor based on real-time data, and may prioritize anchor placement based on metrics, such as network throughput and resource allocation, rather than solely on geographic coverage overlap. The SON system 115 may also reduce a need for intervention by network engineers, and may increase operational efficiency of a network. By prioritizing anchor connections based on actual network performance metrics and service requirements, the SON system 115 may provide targeted improvements to optimize network capacity and handling of high-priority traffic, such as traffic associated with FWA devices 105. Thus, the SON system 115 may conserve computing resources, networking resources, and/or other resources that would have otherwise been consumed by failing to adapt quickly to fluctuating network demands, incorrectly identifying anchors, causing network inefficiencies and connectivity issues due to incorrectly identifying anchors, causing a poor customer experience for a customer of an FWA device 105 due to incorrectly identifying anchors, and/or the like.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

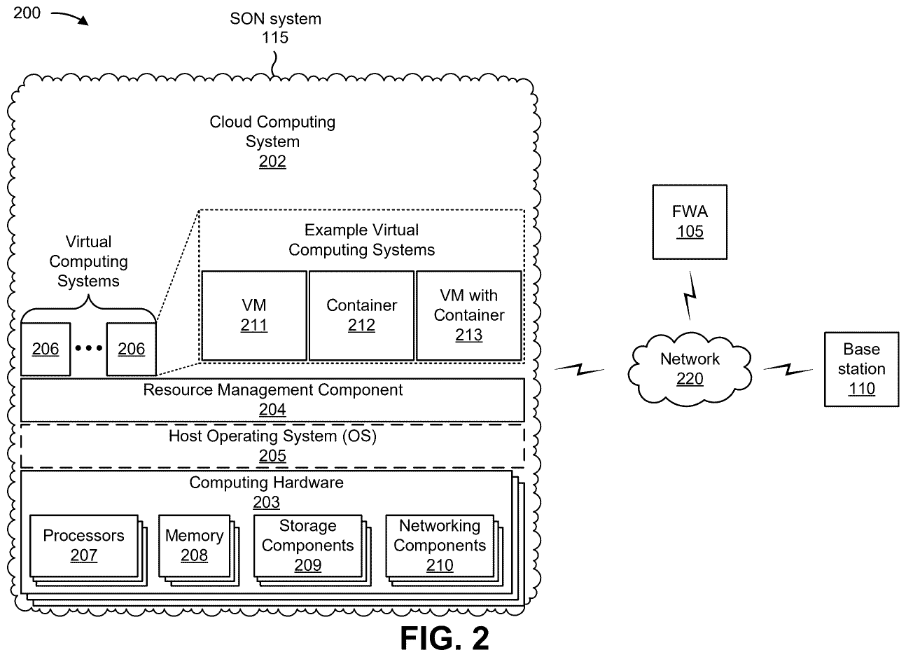

FIG. 2 is a diagram of an example environment 200 in which systems and/or methods described herein may be implemented. As shown in FIG. 2, the environment 200 may include the SON system 115, which may include one or more elements of and/or may execute within a cloud computing system 202. The cloud computing system 202 may include one or more elements 203-213, as described in more detail below. As further shown in FIG. 2, the environment 200 may include the FWA device 105, the base station 110, and/or a network 220. Devices and/or elements of the environment 200 may interconnect via wired connections and/or wireless connections.

The FWA device 105 includes one or more devices capable of receiving, generating, storing, processing, and/or providing information, such as information described herein. For example, the FWA device 105 may include a mobile hotspot device, an FWA device, a customer premise equipment (CPE), an FWA channel service unit, an FWA data service unit, an FWA router, an FWA wireless access point (WAP) device, an FWA modem, an FWA set-top box, or a similar type of device.

The base station 110 includes one or more devices capable of transferring traffic, such as audio, video, text, and/or other traffic, destined for and/or received from a user equipment (UE). For example, the base station 110 may include an eNodeB (eNB) associated with a long term evolution (LTE) network that receives traffic from and/or sends traffic to a core network, a gNodeB (gNB) associated with a RAN of a 5G network, a base transceiver station, a radio base station, a base station subsystem, a cellular site, a cellular tower, an access point, a transmit receive point (TRP), a radio access node, a macrocell base station, a microcell base station, a picocell base station, a femtocell base station, and/or another network entity capable of supporting wireless communication. The base station 110 may support, for example, a cellular radio access technology (RAT). The base station 110 may transfer traffic between a UE (e.g., using a cellular RAT), one or more other base stations 110 (e.g., using a wireless interface or a backhaul interface, such as a wired backhaul interface), and/or a core network. The base station 110 may provide one or more cells that cover geographic areas.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

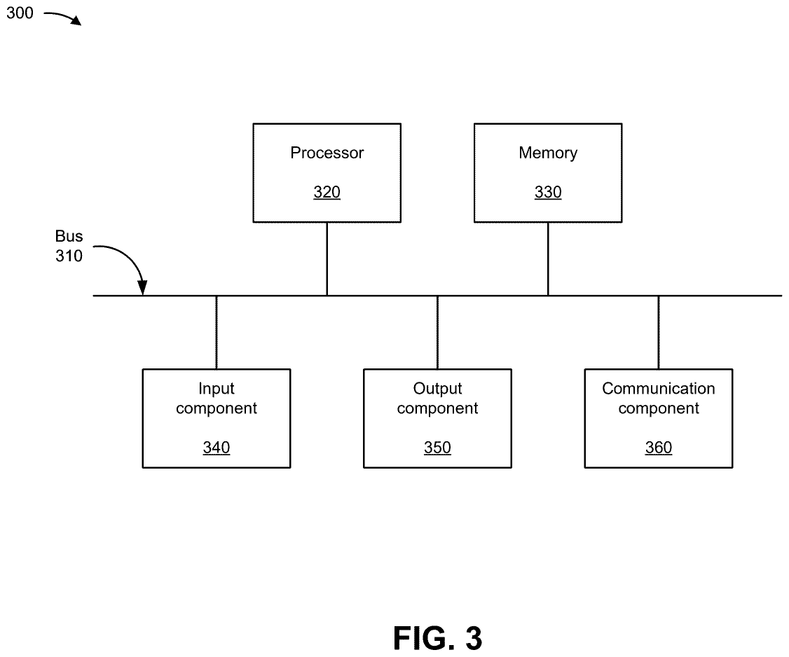

Although the SON system 115 may include one or more elements 203-213 of the cloud computing system 202, may execute within the cloud computing system 202, and/or may be hosted within the cloud computing system 202, in some implementations, the SON system 115 may not be cloud-based (e.g., may be implemented outside of a cloud computing system) or may be partially cloud-based. For example, the SON system 115 may include one or more devices that are not part of the cloud computing system 202, such as the device 300 of FIG. 3, which may include a standalone server or another type of computing device. The SON system 115 may perform one or more operations and/or processes described in more detail elsewhere herein.

The network 220 may include one or more wired and/or wireless networks. For example, the network 220 may include a cellular network (e.g., a 5G network, a 4G network, an LTE network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 220 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the FWA device 105, the base station 110, and/or the SON system 115. In some implementations, the FWA device 105, the base station 110, and/or the SON system 115 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

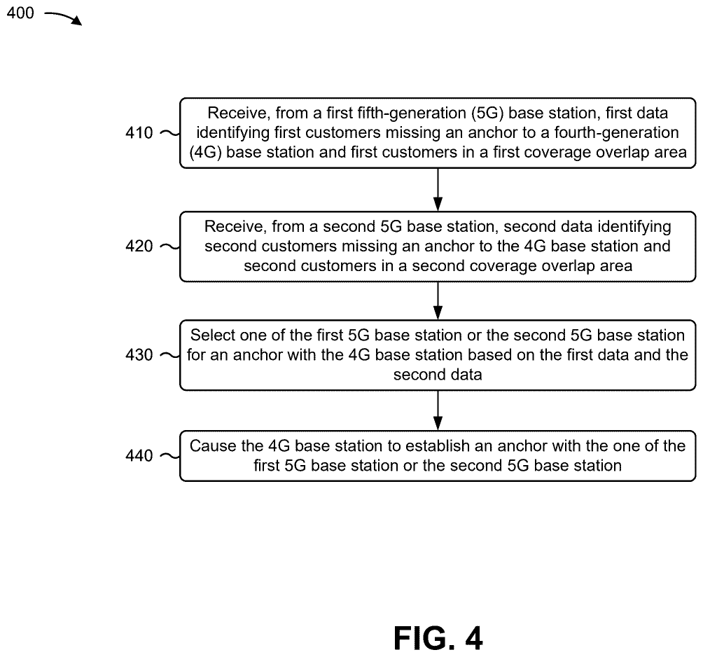

FIG. 4 is a flowchart of an example process 400 for identifying a missing anchor between a 5G base station and a 4G base station. In some implementations, one or more process blocks of FIG. 4 may be performed by a device (e.g., the SON system 115). In some implementations, one or more process blocks of FIG. 4 may be performed by another device or a group of devices separate from or including the device, such as a base station (e.g., the base station 110). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include receiving, from a first 5G base station, first data identifying first customers missing an anchor to a 4G base station and first customers in a first coverage overlap area (block 410). For example, the device may receive, from a first 5G base station, first data identifying first customers missing an anchor to a 4G base station and first customers in a first coverage overlap area, as described above. In some implementations, the first coverage overlap area includes a first coverage area of the first 5G base station that overlaps with a coverage area of the 4G base station, and the second coverage overlap area includes a second coverage area of the second 5G base station that overlaps with the coverage area of the 4G base station. In some implementations, the first data includes data identifying one or more of connection attempts with the first 5G base station, a distance between the 4G base station and the first 5G base station, a utilization rate of the first 5G base station, or plans supported by the first 5G base station, and wherein the second data includes data identifying one or more of connection attempts with the second 5G base station, a distance between the 4G base station and the second 5G base station, a utilization rate of the second 5G base station, or plans supported by the second 5G base station.

As further shown in FIG. 4, process 400 may include receiving, from a second 5G base station, second data identifying second customers missing an anchor to the 4G base station and second customers in a second coverage overlap area (block 420). For example, the device may receive, from a second 5G base station, second data identifying second customers missing an anchor to the 4G base station and second customers in a second coverage overlap area, as described above.

As further shown in FIG. 4, process 400 may include selecting one of the first 5G base station or the second 5G base station for an anchor with the 4G base station based on the first data and the second data (block 430). For example, the device may select one of the first 5G base station or the second 5G base station for an anchor with the 4G base station based on the first data and the second data, as described above. In some implementations, selecting the one of the first 5G base station or the second 5G base station for the anchor with the 4G base station includes selecting the one of the first 5G base station or the second 5G base station for the anchor with the 4G base station based on real-time utilization rates of the first 5G base station, the second 5G base station, and the 4G base station. In some implementations, selecting the one of the first 5G base station or the second 5G base station for the anchor with the 4G base station includes one of selecting the first 5G base station for the anchor with the 4G base station based on a quantity of impacted first customers, associated with the first 5G base station, being less than a quantity of impacted second customers associated with the second 5G base station, or selecting the second 5G base station for the anchor with the 4G base station based on the quantity of impacted first customers being greater than the quantity of impacted second customers.

As further shown in FIG. 4, process 400 may include causing the 4G base station to establish an anchor with the one of the first 5G base station or the second 5G base station (block 440). For example, the device may cause the 4G base station to establish an anchor with the one of the first 5G base station or the second 5G base station, as described above.

In some implementations, process 400 includes identifying a particular 5G base station without an anchor and co-located with the 4G base station, and causing the 4G base station to establish an anchor with the particular 5G base station.

In some implementations, process 400 includes receiving 5G data associated with a plurality of 5G base stations, and receiving 4G data associated with the 4G base station. In some implementations, process 400 includes calculating coverage overlap weights, distance weights, utilization weights, and impact weights based on the 5G data and the 4G data, and calculating relationship scores based on the coverage overlap weights, the distance weights, the utilization weights, and the impact weights. In some implementations, process 400 includes identifying, based on the relationship scores, one of the plurality of 5G base stations without an anchor relationship with the 4G base station, and causing the 4G base station to establish an anchor with the one of the plurality of 5G base stations.

In some implementations, process 400 includes receiving, from a third 5G base station, third data identifying third customers missing an anchor to the 4G base station and third customers with FWA devices in a third coverage overlap area; receiving, from a fourth 5G base station, fourth data identifying fourth customers missing an anchor to the 4G base station and fourth customers with FWA devices in a fourth coverage overlap area; selecting one of the third 5G base station or the fourth 5G base station for an anchor with the 4G base station based on the third data and the fourth data; and causing the 4G base station to establish an anchor with the one of the third 5G base station or the fourth 5G base station. In some implementations, selecting the one of the third 5G base station or the fourth 5G base station for the anchor with the 4G base station includes one of selecting the third 5G base station for the anchor with the 4G base station based on a quantity of impacted third customers with FWA devices being less than a quantity of impacted fourth customers with FWA devices, or selecting the fourth 5G base station for the anchor with the 4G base station based on the quantity of impacted third customers with FWA devices being greater than the quantity of impacted fourth customers with FWA devices.

In some implementations, process 400 includes receiving real-time utilization rates of the first 5G base station, the second 5G base station, and the 4G base station, and removing the anchor between the 4G base station and the one of the first 5G base station or the second 5G base station based on the real-time utilization rates. In some implementations, process 400 includes receiving updated first data and updated second data, selecting another one of the first 5G base station or the second 5G base station for the anchor with the 4G base station based on the updated first data and the updated second data, and causing the 4G base station to establish the anchor with the other one of the first 5G base station or the second 5G base station.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device and from a first fifth-generation (5G) base station, first data identifying first customers missing an anchor to a fourth-generation (4G) base station and first customers in a first coverage overlap area;
receiving, by the device and from a second 5G base station, second data identifying second customers missing an anchor to the 4G base station and second customers in a second coverage overlap area;
selecting, by the device, one of the first 5G base station or the second 5G base station for an anchor with the 4G base station based on the first data and the second data; and
causing, by the device, the 4G base station to establish an anchor with the one of the first 5G base station or the second 5G base station.

2. The method of claim 1, further comprising:
identifying a particular 5G base station without an anchor and co-located with the 4G base station; and
causing the 4G base station to establish an anchor with the particular 5G base station.

3. The method of claim 1, further comprising:
receiving 5G data associated with a plurality of 5G base stations; and
receiving 4G data associated with the 4G base station.

4. The method of claim 3, further comprising:
calculating coverage overlap weights, distance weights, utilization weights, and impact weights based on the 5G data and the 4G data; and
calculating relationship scores based on the coverage overlap weights, the distance weights, the utilization weights, and the impact weights.

5. The method of claim 4, further comprising:
identifying, based on the relationship scores, one of the plurality of 5G base stations without an anchor relationship with the 4G base station; and
causing the 4G base station to establish an anchor with the one of the plurality of 5G base stations.

6. The method of claim 1, wherein the first coverage overlap area includes a first coverage area of the first 5G base station that overlaps with a coverage area of the 4G base station, and the second coverage overlap area includes a second coverage area of the second 5G base station that overlaps with the coverage area of the 4G base station.

7. The method of claim 1, wherein selecting the one of the first 5G base station or the second 5G base station for the anchor with the 4G base station comprises:
selecting the one of the first 5G base station or the second 5G base station for the anchor with the 4G base station based on real-time utilization rates of the first 5G base station, the second 5G base station, and the 4G base station.

8. A device, comprising:
one or more processors configured to:
receive, from a first fifth-generation (5G) base station, first data identifying first customers missing an anchor to a fourth-generation (4G) base station and first customers in a first coverage overlap area,
wherein the first coverage overlap area includes a first coverage area of the first 5G base station that overlaps with a coverage area of the 4G base station;
receive, from a second 5G base station, second data identifying second customers missing an anchor to the 4G base station and second customers in a second coverage overlap area,
wherein the second coverage overlap area includes a second coverage area of the second 5G base station that overlaps with the coverage area of the 4G base station;
select one of the first 5G base station or the second 5G base station for an anchor with the 4G base station based on the first data and the second data; and
cause the 4G base station to establish an anchor with the one of the first 5G base station or the second 5G base station.

9. The device of claim 8, wherein the one or more processors, to select the one of the first 5G base station or the second 5G base station for the anchor with the 4G base station, are configured to one of:
select the first 5G base station for the anchor with the 4G base station based on a quantity of impacted first customers, associated with the first 5G base station, being less than a quantity of impacted second customers associated with the second 5G base station; or
select the second 5G base station for the anchor with the 4G base station based on the quantity of impacted first customers being greater than the quantity of impacted second customers.

10. The device of claim 8, wherein the one or more processors are further configured to:
receive, from a third 5G base station, third data identifying third customers missing an anchor to the 4G base station and third customers with fixed wireless access (FWA) devices in a third coverage overlap area;
receive, from a fourth 5G base station, fourth data identifying fourth customers missing an anchor to the 4G base station and fourth customers with FWA devices in a fourth coverage overlap area;
select one of the third 5G base station or the fourth 5G base station for an anchor with the 4G base station based on the third data and the fourth data; and
cause the 4G base station to establish an anchor with the one of the third 5G base station or the fourth 5G base station.

11. The device of claim 10, wherein the one or more processors, to select the one of the third 5G base station or the fourth 5G base station for the anchor with the 4G base station, are configured to one of:
select the third 5G base station for the anchor with the 4G base station based on a quantity of impacted third customers with FWA devices being less than a quantity of impacted fourth customers with FWA devices; or
select the fourth 5G base station for the anchor with the 4G base station based on the quantity of impacted third customers with FWA devices being greater than the quantity of impacted fourth customers with FWA devices.

12. The device of claim 8, wherein the one or more processors are further configured to:
receive real-time utilization rates of the first 5G base station, the second 5G base station, and the 4G base station; and
remove the anchor between the 4G base station and the one of the first 5G base station or the second 5G base station based on the real-time utilization rates.

13. The device of claim 8, wherein the one or more processors are further configured to:
receive updated first data and updated second data;
select another one of the first 5G base station or the second 5G base station for the anchor with the 4G base station based on the updated first data and the updated second data; and
cause the 4G base station to establish the anchor with the other one of the first 5G base station or the second 5G base station.

14. The device of claim 8, wherein the first data includes data identifying one or more of connection attempts with the first 5G base station, a distance between the 4G base station and the first 5G base station, a utilization rate of the first 5G base station, or plans supported by the first 5G base station, and
wherein the second data includes data identifying one or more of connection attempts with the second 5G base station, a distance between the 4G base station and the second 5G base station, a utilization rate of the second 5G base station, or plans supported by the second 5G base station.

15. A non-transitory computer-readable medium storing a set of instructions, the set of instructions comprising:
one or more instructions that, when executed by one or more processors of a device, cause the device to:
receive, from a first fifth-generation (5G) base station, first data identifying first customers missing an anchor to a fourth-generation (4G) base station and first customers in a first coverage overlap area,
wherein the first data includes data identifying one or more of connection attempts with the first 5G base station, a distance between the 4G base station and the first 5G base station, a utilization rate of the first 5G base station, or plans supported by the first 5G base station;
receive, from a second 5G base station, second data identifying second customers missing an anchor to the 4G base station and second customers in a second coverage overlap area,
wherein the second data includes data identifying one or more of connection attempts with the second 5G base station, a distance between the 4G base station and the second 5G base station, a utilization rate of the second 5G base station, or plans supported by the second 5G base station;
select one of the first 5G base station or the second 5G base station for an anchor with the 4G base station based on the first data and the second data; and
cause the 4G base station to establish an anchor with the one of the first 5G base station or the second 5G base station.

16. The non-transitory computer-readable medium of claim 15, wherein the one or more instructions further cause the device to:
identify a particular 5G base station without an anchor and co-located with the 4G base station; and
cause the 4G base station to establish an anchor with the particular 5G base station.

17. The non-transitory computer-readable medium of claim 15, wherein the one or more instructions further cause the device to:
receive 5G data associated with a plurality of 5G base stations;
receive 4G data associated with the 4G base station;
calculate coverage overlap weights, distance weights, utilization weights, and impact weights based on the 5G data and the 4G data;
calculate relationship scores based on the coverage overlap weights, the distance weights, the utilization weights, and the impact weights;
identify, based on the relationship scores, one of the plurality of 5G base stations without an anchor relationship with the 4G base station; and
cause the 4G base station to establish an anchor with the one of the plurality of 5G base stations.

18. The non-transitory computer-readable medium of claim 15, wherein the one or more instructions, that cause the device to select the one of the first 5G base station or the second 5G base station for the anchor with the 4G base station, cause the device to:
select the one of the first 5G base station or the second 5G base station for the anchor with the 4G base station based on real-time utilization rates of the first 5G base station, the second 5G base station, and the 4G base station.

19. The non-transitory computer-readable medium of claim 15, wherein the one or more instructions, that cause the device to select the one of the first 5G base station or the second 5G base station for the anchor with the 4G base station, cause the device to one of:
select the first 5G base station for the anchor with the 4G base station based on a quantity of impacted first customers, associated with the first 5G base station, being less than a quantity of impacted second customers associated with the second 5G base station; or
select the second 5G base station for the anchor with the 4G base station based on the quantity of impacted first customers being greater than the quantity of impacted second customers.

20. The non-transitory computer-readable medium of claim 15, wherein the one or more instructions further cause the device to:
receive, from a third 5G base station, third data identifying third customers missing an anchor to the 4G base station and third customers with fixed wireless access (FWA) devices in a third coverage overlap area;
receive, from a fourth 5G base station, fourth data identifying fourth customers missing an anchor to the 4G base station and fourth customers with FWA devices in a fourth coverage overlap area;
select one of the third 5G base station or the fourth 5G base station for an anchor with the 4G base station based on the third data and the fourth data; and
cause the 4G base station to establish an anchor with the one of the third 5G base station or the fourth 5G base station.
